(19) United States
(12) Patent Application Publication
(10) Pub. No.: US 2006/0089072 A1
(43) Pub. Date: Apr. 27, 2006

(54) Composite filtration media

(75) Inventors: John Frank Baker JR., Nashville, TN (US); Peter J. Angelini, Hendersonville, TN (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Reemay, Inc.

(21) Appl. No.: 11/249,087

(22) Filed: Oct. 12, 2005

Related U.S. Application Data
(60) Provisional application No. 60/622,316, filed on Oct. 26, 2004.

(51) Int. Cl. B32B 27/04; D04H 13/00; B32B 27/12; D04H 3/16

(52) U.S. Cl. 442/394; 442/401; 442/337; 442/123

(57) ABSTRACT

The filtration medium is of a composite construction and includes a liquid permeable nonwoven fabric substrate and a liquid permeable film layer of polyolefin resin adhered to one surface of the nonwoven fabric substrate and forming one of the exposed surfaces of the filtration medium. An antimicrobial agent is incorporated in the film layer. Preferably, the liquid permeable film layer is a polyolefin film having a plurality of liquid permeable apertures extending therethrough. The antimicrobial agent is blended with the polyolefin resin prior to extrusion of the film so that it is present throughout the film layer. The antimicrobial agent may be present in the film layer at a concentration of from 0.01% to 5% by weight, based on the weight of the film layer.

### CROSS-REFERENCE TO RELATED APPLICATIONS

This application is related to and claims priority from U.S. Provisional Patent Application No. 60/622,316 filed Oct. 26, 2004.

### BACKGROUND OF THE INVENTION

The present invention relates to filtration media, and more particularly to liquid filtration media suitable for use in pool and spa filters.

Pools and spas typically include a filtration system through which the water is circulated to remove dirt, debris and other foreign matter. Many of the filtration systems utilize a replaceable filter cartridge of a generally cylindrical form containing a filter element of a pleated construction. The filter element is typically made of a pleated polyester nonwoven fabric material. One such nonwoven fabric material that has been in widespread use for a number of years is sold by BBA Fiberweb under the trademark Reemay® and comprises a spunbond nonwoven fabric formed of polyester filaments bonded together to form a coherent strong pleatable nonwoven fabric filtration medium.

In order to inhibit the growth of microorganisms on the surface of the pool and spa filter element, antimicrobial agents can be incorporated in the nonwoven filtration media. Conventional methods of adding an antimicrobial agent to filtration media include incorporating antimicrobial particles, such as silver chloride, into the fiber structure during melt extrusion of the fibers or subjecting the fibers or the filtration media to a dyeing operation to achieve penetration of the antimicrobial agent into the fiber. Dyeing the fibers is not a viable option for those nonwoven fabric manufacturing processes where fiber formation and nonwoven fabric formation occur in-line, such as the spunbond or meltblown processes. Dyeing the nonwoven fabric after its formation to incorporate the antimicrobial agent is slow and requires additional processing operations that undesirably add to the expense of producing the filtration media. While some antimicrobial agents can be incorporated into the fibers of a nonwoven fabric by melt extrusion during fabric formation, many of the available antimicrobial agents can not applied in this manner since they are thermally degraded at the extrusion temperatures of the fiber-forming polymers. A further limitation of the existing polyester filtration media is that the filter cartridges are rather difficult to clean. Although the polyester nonwoven fabric effectively removes contaminants, cleaning of the filter cartridge is difficult and can result in damage to or deterioration of the filter element.

Accordingly, there exists a need for improved filtration media that overcomes the aforementioned limitations and problems.

### BRIEF SUMMARY OF THE INVENTION

The present invention provides a liquid filtration medium that overcomes one or more of the aforementioned limitations. The filtration medium is of a composite construction and includes a liquid permeable nonwoven fabric substrate and a liquid permeable film layer of polyolefin resin adhered to one surface of the nonwoven fabric substrate and forming one of the exposed surfaces of the filtration medium. An antimicrobial agent is incorporated in the film layer. Preferably, the liquid permeable film layer is a polyolefin film having a plurality of liquid permeable apertures extending therethrough. The antimicrobial agent is blended with the polyolefin resin prior to extrusion of the film so that it is present throughout the film layer. The antimicrobial agent may be present in the film layer at a concentration of from 0.01% to 5% by weight, based on the weight of the film layer.

In one advantageous embodiment of the invention, the liquid permeable nonwoven fabric substrate comprises a spunbond nonwoven fabric formed from substantially continuous polyester filaments bonded to one another to form a strong coherent fabric. The spunbond nonwoven fabric may have a basis weight of from 12 to 204 grams per square meter.

The liquid permeable apertured film layer is bonded to one surface of the spunbond nonwoven fabric substrate and forms one of the exposed surfaces of the composite filtration medium. The presence of the film layer presents a relatively slick surface to the composite filtration medium. This slick surface on the film side of the composite medium is desirable since many pool and spa filters are used for a period of time and are then removed and rinsed to remove the accumulated dirt and debris that has built up on the filter element. The normally porous nature of conventional polyester filtration media allows for rinsing of the filter element, but complete removal of the accumulated debris cake is difficult. The slick surface provided by the film layer facilitates rinsing and cleaning, since the accumulated cake is more readily released from the filter element.

The presence of the antimicrobial agent in the film layer inhibits the growth of microorganisms on the filter element. By incorporating the antimicrobial agent into the polyolefin resin film layer, an antimicrobial film is produced at temperatures that will not thermally degrade the antimicrobial agent. A further benefit of the film layer is that it will more readily remove body oils that accumulate in spas and hot tubs since these oils have an affinity to the polyolefin resin composition of the film layer.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a perspective view of a filter cartridge;

FIG. 2 is a cross-sectional view thereof taken substantially along the line 2-2 of FIG. 1;

FIG. 3 is a schematic perspective view of a composite filtration medium in accordance with the invention;

FIG. 4 is a scanning electron microscope photograph (SEM) at 50× magnification showing the top surface of a composite filtration medium in accordance with the present invention;

FIG. 5 is a SEM at 120× magnification showing the filtration medium of FIG. 4 in cross-section;

FIG. 6 is a graph comparing the turbidity reduction of the filtration medium with a control; and

FIG. 7 is a graph comparing the plug time of the filtration medium with a control.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

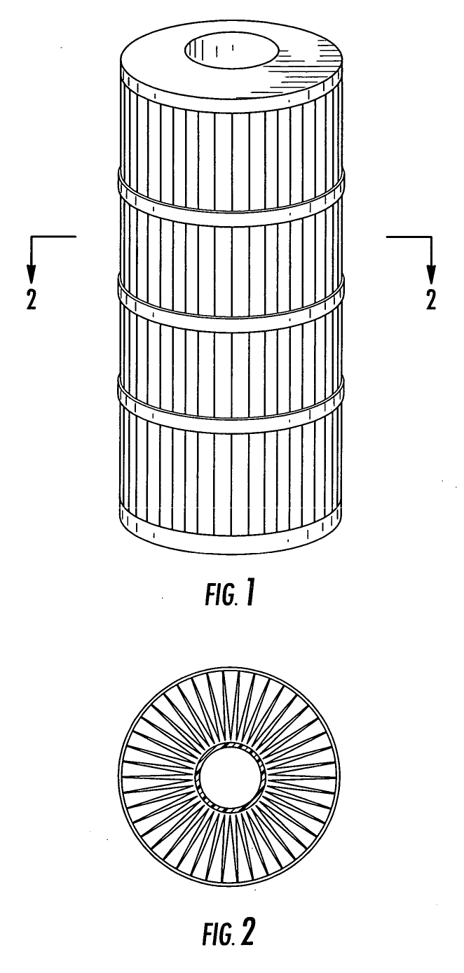

A filter cartridge of the type commonly used spa and pool filters is shown in FIG. 1. The filter cartridge includes end caps 11, 12 and a filter element 13 mounted between the end caps. The filter element 13 is of a generally cylindrical configuration and is of a pleated construction. More particularly, as best seen in FIG. 2, the filter element 13 is formed by a filtration medium 20 which has been pleated along parallel pleat lines or folds 15 that extend parallel to the longitudinal axis of the cylindrical filter element. The pleated construction of the filter element 13 provides for the exposure of a large surface area of the filtration medium to the flow of water.

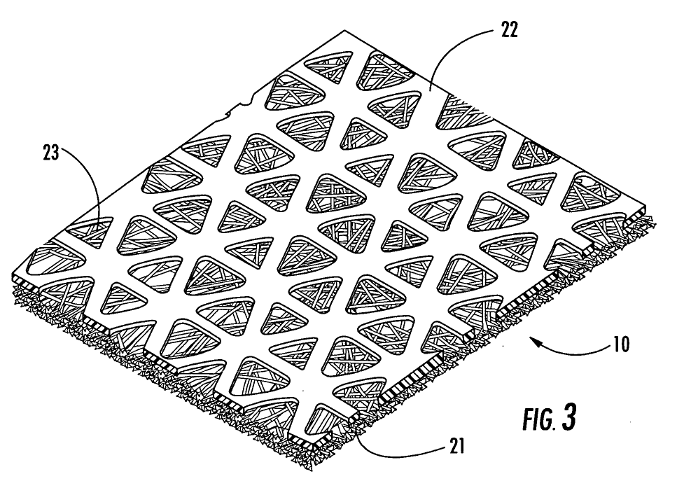

One embodiment of a filtration medium 20 in accordance with the present invention is shown in greater detail in FIGS. 3, 4 and 5. This filtration medium is readily susceptible to pleating and can be used to form a filter element of the type shown in FIGS. 1 and 2. The filtration medium 20 is of a composite construction and includes a liquid permeable nonwoven fabric substrate 21 and a liquid permeable film layer overlying and adhered to one surface of the nonwoven fabric substrate 21 and forming one of the exposed surfaces of the composite filtration medium 20.

The nonwoven fabric substrate 21 has a thickness, basis weight and stiffness that allows for pleating using commercially available pleating processes and machinery, such as rotary and push-bar type pleaters. The substrate 21 is capable of being formed into sharp creases or folds without loss of strength, and of maintaining its shape in the creased or pleated condition. The nonwoven fabric substrate 21 can be produced by any of a number of nonwoven manufacturing processes well known in the industry, including carding, wet laying, air laying, and spunbonding. In the embodiment illustrated, the substrate is a fully bonded air permeable nonwoven fabric formed of continuous filaments. Preferably, the nonwoven fabric is a spunbond nonwoven fabric. Examples of various types of processes for producing spunbond fabrics are described in U.S. Pat. No. 3,338,992 to Kinney, U.S. Pat. No. 3,802,817 to Matsuki, U.S. Pat. No. 4,405,297 to Appel, U.S. Pat. No. 4,812,112 to Balk, and U.S. Pat. No. 5,665,300 to Brignola et al. In general, these spunbond processes include steps of extruding molten polymer filaments from a spinneret; quenching the filaments with a flow of air to hasten the solidification of the molten polymer; attenuating the filaments by advancing them with a draw tension that can be applied by either pneumatically entraining the filaments in an air stream or by wrapping them around mechanical draw rolls of the type commonly used in the textile fibers industry; depositing the attenuated filaments randomly onto a collection surface, typically a moving belt, to form a web; and bonding the web of loose filaments. The continuous filaments are bonded to each other at points of contact to impart strength and integrity to the nonwoven web. The bonding can be accomplished by various known means, such as by the use of binder fibers, resin bonding, thermal area bonding, calendering, point bonding, ultrasonic bonding and the like. The filaments are bonded to each other at points of contact, but the nonwoven structure remains sufficiently open to provide the requisite air and water permeability.

In one advantageous embodiment, the filaments are bonded at a plurality of crossover points throughout the fabric. This type of bonding is commonly referred to as “area bonding”, and is different from “point bonding” where the fibers are bonded to one another at discrete spaced apart bond sites, usually produced by a patterned or engraved roll. In certain preferred embodiments of the present invention, the filaments of the nonwoven fabric substrate are bonded by binder fibers having a lower melting temperature than the primary filaments of the nonwoven fabric. The binder fibers are typically present in amounts ranging independently from about 2 to 20 weight percent, such as an amount of about 10 weight percent. They are preferably formed from a thermoplastic polymer exhibiting a melting or softening temperature at least about 10° C. less than that of the primary continuous filaments. For example, where the primary filaments of the nonwoven fabric substrate 21 are polyester, such as polyethylene terephthalate, the binder fiber is formed from a lower melting polyester copolymer, particularly polyethylene isophthalate copolymer. It should be noted that although binder fibers are incorporated into the nonwoven fabric during manufacture, in many instances, the binder fibers may not be separately identifiable in the nonwoven fabric after bonding because the binder fibers have softened or flowed to form bonds with the continuous filaments of the nonwoven layers. One advantage of using binder fibers for bonding the layers is that there is no added chemical binder present in the nonwoven fabric substrate 21.

Preferably, the spunbond nonwoven fabric is formed of a synthetic fiber-forming polymer which is hydrophobic in nature and has good chemical resistance to avoid degradation from contact with chemicals commonly used in treating pool and spa water. Among the well known synthetic fiber-forming polymers, polyester polymers and copolymers are recognized as being suitable for producing hydrophobic nonwoven webs that are resistant to degradation from chlorine and bromine based chemical used in pool and spa water treatment. Examples of suitable spunbond polyester nonwoven fabrics for use in the present invention include nonwoven fabrics sold by BBA Fiberweb under the trademark REEMAY, including Style Nos. 2033, 2040, 2295 and 2470, as well as point bonded spunbond polyester fabric sold under the trademark DIAMOND WEB, and multi-denier spunbond polyester fabric sold under the trademark REEMAY® X-TREME™.

The spunbond nonwoven fabric substrate may have a basis weight of from 12 to 204 grams per square meter, and more desirably from about 30 to 170 grams per square meter. The continuous filaments of the web preferably have a denier per filament of approximately 1 to 6 and the filaments can have a cross-section ranging from round to trilobal or quadralobal or can include varying cross-sections and varying deniers.

The nonwoven fabric substrate 21 preferably has a thickness of from 0.4 to 0.9 millimeters. The thickness of the substrate affects both its filtration characteristics and its pleatability. Too thin a substrate will result in the filtration taking place primarily at the fabric surface. The filter will be easier to clean, but it will clog much more quickly. Thicker materials provide some depth filtration along with surface filtration, which will extend the time required between cleanings. Thickness also affects the pleating and the quality of the final pleat, since fabric thickness is directly related to stiffness. Overly thin materials will not have sufficient stiffness to retain a pleat, and the pleats will tend to collapse upon themselves. Overly thick materials are so stiff that they will form poor pleats or will tend to return to the original unpleated configuration.

Substrate thickness also affects the performance of the fabric as a filtration medium. One important performance characteristic of a filtration medium is turbidity reduction. This measures filtration efficiency in terms of the number of tank or volume turnovers required to reach a desired level of turbidity or water clarity. The NSF/ANSI Standard 50 outlines a turbidity reduction test in Annex B.5. A second performance characteristic of filtration media is plug time. This measures the time interval between required filter cleanings. An effective filter medium must balance these two countervailing characteristics in order to provide filtration efficiency with a reasonable rate of filtering while also providing a suitable time interval between the need to clean or replace the filter. The thickness and permeability of the nonwoven fabric substrate directly affect these properties. For example, a substrate with a relatively high permeability will take longer to remove particulate matter from the water but the interval between cleanings will be greater. Conversely, if the permeability of the substrate is relatively low, filtering efficiency will be high but the time between required cleanings will be too short. However, if permeability is too large, smaller particles may never be captured and the water will be more turbid than desired.

The permeability of the nonwoven fabric substrate 21 may be conveniently evaluated by measuring its air permeability using a commercially available air permeability instrument, such as the Textest air permeability instrument, in accordance with the air permeability test procedures outlined in ASTM test method D-1117. Preferably, the nonwoven fabric substrate should have an air permeability, as measured by this procedure, of from 150 to 270.

If additional stiffness is desired for the nonwoven fabric substrate beyond that obtained from the initial nonwoven manufacturing operation, a stiffening coating (not shown) may be applied to one or both surfaces of the nonwoven fabric substrate. More particularly, at least one of the exposed surfaces may be provided with a resin coating for imparting additional stiffness to the nonwoven fabric so that the fabric may be pleated by conventional pleating equipment. By varying the amount of resin coating applied, the air permeability of the nonwoven fabric substrate may also be controlled as required for specific filtration applications. The resin coating may be applied to the nonwoven fabric using conventional coating techniques such as spraying, knife coating, reverse roll coating, or the like. Exemplary resins include acrylic resin, polyesters, nylons or the like. The resin may be supplied in the form of an aqueous or solvent-based high viscosity liquid or paste, applied to the nonwoven fabric, e.g. by knife coating, and then dried by heating.

The liquid permeable film layer 22 is formed of a thermoplastic polyolefin resin and preferably has a basis weight of from 10 to 50 grams per square meter. The liquid permeability of the film is attributable to the presence of a multiplicity of apertures formed in the film. The apertures are present throughout the surface of the film and form a significant proportion of the surface area of the film, Preferably, the apertures constitute at least 25% of the surface area of the film, and more desirably, 35% or greater. The film may suitably be produced as a separate free-standing film which is subsequently rendered air and water permeable by a suitable perforating or aperturing process, and the apertured film is subsequently laminated to one surface of the nonwoven fabric substrate.

Preferably the liquid permeable film layer 22 should have an air permeability prior to combining with the nonwoven substrate 21 of at least 150 cfm/ft²/min, and desirably at least 800 cfm/ft²/min., as measured using a Textest air permeability instrument in accordance with test standard ASTM D-1117.

In one suitable embodiment, the film layer 22 is produced by extruding the molten polyolefin resin from a film die, cooling the film, embossing the film and then orienting the film in the machine and/or cross-machine direction so that areas of the film rupture to produce a uniform pattern of apertures of similar size and shape throughout the film. A process and resulting film of this type is described, for example, in U.S. Pat. Nos. 5,207,923 and 5,262,107, the contents of which are incorporated herein by reference. Suitable apertured film of this type is commercially available from DelStar Technologies, Inc. under the registered trademark DELNET®. Other apertured films for use in the present invention may be produced using apertured film processes controlled by Tredegar, Inc. of Richmond, Va.

In a preferred embodiment, the polyolefin film layer is formed from a polyethylene resin, and most desirably from high density polyethylene. Alternatively, the film layer 22 may comprise more than one polymer composition, such as a coextrusion of a polyethylene resin with one or more adhesive-forming copolymer outer layers (e.g. EAA copolymer) that will facilitate thermal lamination of the film layer 22 to the nonwoven fabric substrate 21.

Prior to extrusion, the polyethylene resin may be blended with additives of the type conventionally used in film extrusion such as slip agents, stabilizers, antioxidants, pigments and the like. In addition, in accordance with the present invention, an antimicrobial agent is blended with the polyethylene resin. Preferably, the antimicrobial agent is present in the film layer 22 at a concentration of from 0.01% to 5% by weight, based on the weight of the film layer. The specific concentration employed is dictated by the type of antimicrobial agent used and the target organisms, and can be readily determined without undue experimentation using routine screening tests.

The antimicrobial is a broad spectrum antimicrobial agent that is effective against the majority of harmful bacteria encountered in water. For example, an antimicrobial agent such as 2,4,4′-trichloro-2′-hydroxydiphenol ether, or 5-chloro-2-phenol (2,4-dichlorophenoxy) compounds commonly sold under the trademark MICROBAN® B by Microban Products Company, Huntersville, N.C. typically will be used. However, it will be understood that various other antimicrobial agents that are safe, nontoxic and substantially insoluble in water can be used in the present invention.

The antimicrobial-containing apertured film 22 is bonded to one surface of the liquid permeable nonwoven fabric substrate 21. The bonding can be carried out using an additional adhesive agent or the film can be laminated directly to the nonwoven fabric substrate by ultrasonic bonding or by heat and pressure. For example, the film layer 22 may be laminated directly to one surface of the nonwoven fabric substrate 21 by passing the two layers through a nip formed by a cooperating pair of heated, smooth-surfaced calender rolls.

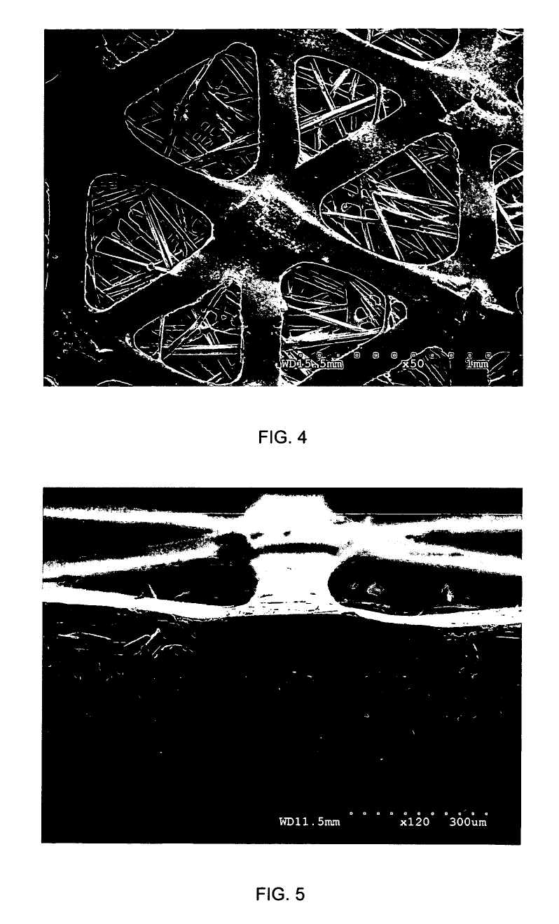

As can be seen from the scanning electron microscope photograph of FIG. 4, the apertures of the film layer 22 are considerably larger than the interstices defined by the intersecting filaments of the underlying nonwoven fabric substrate 21. Because of the relatively large size of the apertures, the presence of the film layer 22 does not impair the fluid flow properties or the filtration capabilities of nonwoven fabric substrate 21. FIG. 5 clearly reveals the trilobal cross-sectional configuration of the filaments of the nonwoven fabric substrate 21. It can also be seen that the nonwoven fabric substrate 21 has a thickness significantly greater that that of the apertured film layer 22, and that the film layer is firmly bonded to the nonwoven fabric substrate. The film layer is bonded to the nonwoven layer by fusion bonds resulting from the softening of the film layer, and in addition, there is a mechanical bond resulting from the filaments at the surface of the nonwoven fabric substrate becoming embedded in the film layer.

When the composite filtration medium 20 is fabricated into a filter element, such as a pleated filter element 13 of the type shown in FIGS. 1 and 2, film layer 22 is desirably oriented toward the direction of liquid flow through the filter so that the build-up or cake of dirt and debris that is separated from the water flow will accumulate on the slick surface presented by the film layer 22. This will facilitate rinsing and cleaning of the filter cartridge. Thus, in filter systems which circulate the liquid through the filter cartridge from the outside toward the inside, the film layer 22 will be oriented outwardly in the filter element.

The presence of the antimicrobial agent in the film layer 22 effectively inhibits the grown of microorganisms on the surface of the filter element 13 during the filtration operation and even after repeated cleanings of the filter cartridge. Because the antimicrobial agent is dispersed throughout the film thickness, it can diffuse to the surface of the film to provide for long-lasting controlled release of the antimicrobial agent during the effective life of the filter cartridge.

### EXAMPLE 1

A roll of spunbond polyester nonwoven fabric filtration medium produced as Reemay® grade 2033 by Reemay Inc., doing business as BBA Fiberweb, having the properties shown in Table 1 below was placed on an unwind stand. The nonwoven fabric filtration medium is formed from polyethylene terephthalate filaments of a generally trilobal cross-section having a linear density of 4 denier per filament. The fabric is area bonded by a polyethylene isophthalate copolymer binder. A roll of apertured high density polyethylene film produced by DelStar Technologies, Inc. and having the properties shown in Table 1 was mounted on a second unwind stand. As the nonwoven fabric was unrolled from the roll, the film was unrolled and directed onto one surface of the nonwoven fabric filtration. These two layers were directed through a nip formed by heated smooth-surfaced calender rolls to laminate the film layer to the nonwoven fabric layer, producing a composite filtration medium having the basis weight, thickness and air permeability described in Table 1.

TABLE 1

| | Nonwoven fabric | Film | Combined |
|---|---|---|---|
| Unit Weight, gsm | 100 | 18 | 118 |
| Thickness, mm | 0.43 | 0.14 | 0.39 |
| Air Perm, cfm | 256 | 800 | 164 |
| Other | 100% | Anti-microbial | Heat laminated |
| | 4 dpf | content | construction |
| | trilobal fibers | 1,500 PPM | |
| | | Microban ® B | |

### EXAMPLE 2

Samples of the composite filtration medium of Example 1 were subjected to testing for compliance with the National Sanitation Foundation (NSF) requirements for pool and spa filters. The samples were tested in accordance with FDA standard 21 C.F.R. §177.1630 for polyester fabrics and 21 C.F.R. §177.1520 for polyolefin fabrics for extractives. The extractives were well under the limits specified in these regulations, as seen in the following table.

| Test | Standard | Sample | Sample | Sample |
|---|---|---|---|---|
| 21 CFR | Max. | Chloroform | Chloroform | Chloroform |
| 177.1630 | chloroform- | soluble | soluble | soluble |
| | soluble | extractives | extractives | extractives |
| | extractives | from water | from | from 50% |
| | | | heptane | ethanol |
| | 0.2 | 0.0000 | 0.0144 | 0.0308 |
| 21 CFR | Max. | Extractable | | |
| 177.1520 | extractable | fraction in | | |
| | fraction in | n-hexane | | |
| | n-hexane | | | |
| | 6.4 | 0.0556 | | |
| | Max. | Extractable | | |
| | extractable | fraction in | | |
| | fraction in | xylene | | |
| | xylene | | | |
| | 9.8 | 1.31 | | |

### EXAMPLE 3

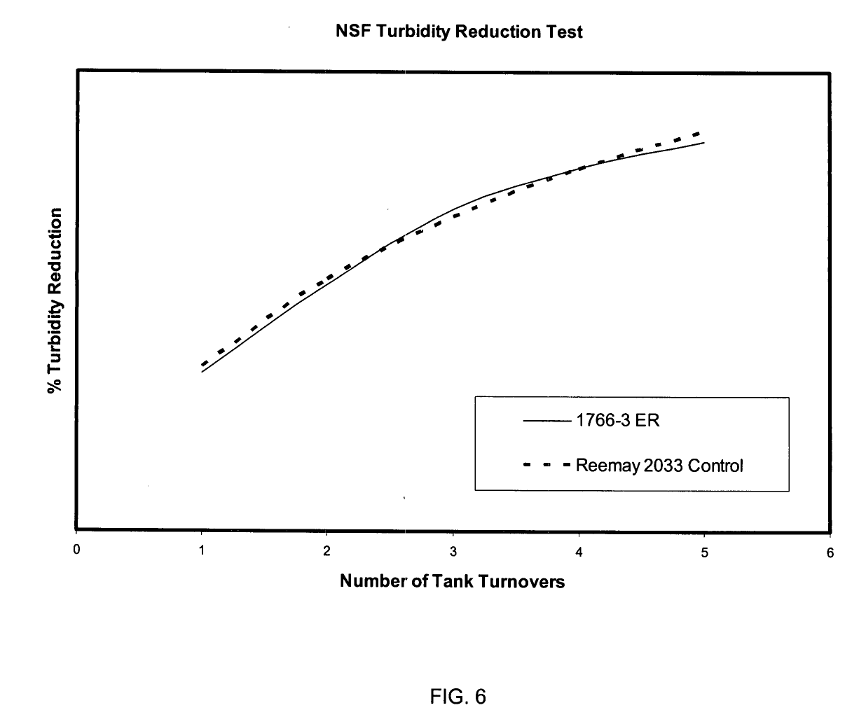

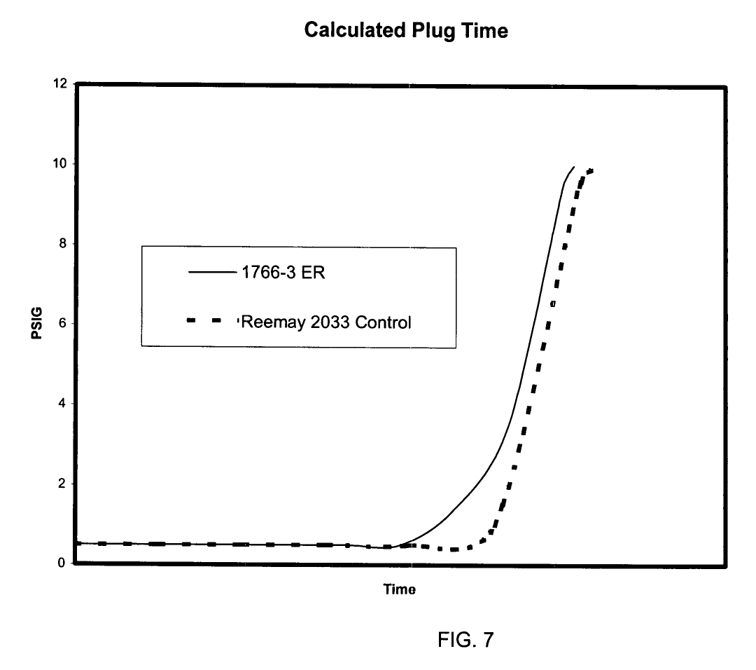

The turbidity reduction and the plug time characteristics of the composite filtration medium of Example 1 were compared to a control sample formed of the Reemay 2033 spunbond nonwoven fabric alone. Turbidity reduction was measured in accordance with the NSF/ANSI Standard 50. Plug time was evaluated by monitoring the pressure drop across the filter versus time. The comparative results are shown graphically in FIGS. 6 and 7. The graphs show that the composite medium of the invention (identified as 1766-3 ER) exhibits turbidity reduction comparable to that of the control sample, and that the additional presence of the apertured film layer did not alter the pressure drop across the filter during normal operation and did not significantly reduce the plug time. After the plug time test, the two samples were rinsed to remove the accumulated filter cake. The filter cake was readily removed from the composite filtration medium of the invention by rinsing under running water. In the control sample, some of the filter cake was rinsed off, but some remained adhered to the control sample.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A composite filtration medium for liquids, comprising a liquid permeable nonwoven fabric substrate, a liquid permeable film layer of polyolefin resin adhered to one surface of the nonwoven fabric substrate and forming one of the exposed surfaces of the filtration medium, and an antimicrobial agent incorporated in the film layer.

2. The filtration medium of claim 1, wherein the liquid permeable film layer comprises a film of polyolefin resin having a plurality of liquid permeable apertures extending therethrough.

3. The filtration medium of claim 2, wherein the film layer has a basis weight of from 10 to 50 grams per square meter.

4. The filtration medium of claim 1, wherein the antimicrobial agent is present in the film layer at a concentration of from 0.01% to 5% by weight, based on the weight of the film layer.

5. The filtration medium of claim 1, wherein the antimicrobial agent is selected from the group consisting of 2,4,4′-trichloro-2-hydroxy diphenol ether and 5-chloro-2-phenol (2,4 dichlorophenoxy) compounds.

6. The filtration medium of claim 1, wherein the liquid permeable nonwoven fabric substrate forms the opposite surface of the composite filtration medium.

7. The filtration medium of claim 1, wherein the liquid permeable nonwoven fabric substrate comprises a spunbond nonwoven fabric formed from substantially continuous thermoplastic polymer filaments bonded to one another to form a strong coherent fabric.

8. The filtration medium of claim 7, wherein the spunbond nonwoven fabric has a basis weight of 12 to 204 grams per square meter.

9. The filtration medium of claim 1, wherein the liquid permeable nonwoven fabric substrate has a thickness of 0.4 to 0.9 mm and an air permeability of from 150 to 270 cfm/ft²/min.

10. The filtration medium of claim 1 wherein said composite medium has an air permeability of at least 150 cfm/ft²/min.

11. A composite filtration medium for liquids, comprising a liquid permeable spunbond nonwoven fabric substrate formed of continuous filaments, a liquid permeable apertured film layer of polyethylene resin bonded to one surface of the nonwoven fabric substrate and forming one of the exposed surfaces of the composite filtration medium, and an antimicrobial agent incorporated in the film layer.

12. The filtration medium of claim 11, wherein the substantially continuous filaments of the nonwoven fabric substrate include polyester filaments of a trilobal cross-section.

13. A composite filtration medium for liquids, comprising a liquid permeable spunbond nonwoven fabric substrate having a basis weight of from 12 to 204 grams per square meter, a thickness of from 0.4 to 0.9 millimeters, and formed of continuous filaments bonded to one another, a liquid permeable polyethylene film layer bonded to one surface of the nonwoven fabric substrate and forming one of the exposed surfaces of the composite filtration medium, the film layer having a multiplicity of apertures formed therethrough to render the film layer liquid permeable, the apertures defining an open area of at least 25% of the surface area of the film layer, and an antimicrobial agent incorporated in the film layer.

14. The filtration medium of claim 13, wherein the substantially continuous filaments of the nonwoven fabric substrate include polyester filaments of a trilobal cross-section.

15. The filtration medium of claim 14, wherein the film layer has an open area of 35% or greater.

16. The filtration medium of claim 13, wherein the antimicrobial agent is present in the film layer at a concentration of from 0.01% to 5% by weight, based on the weight of the film layer.

17. A filter element for pools or spas comprising the filtration medium of claim 1.

18. The filter element of claim 17, which has a generally cylindrical configuration about a central axis and wherein the filtration medium is formed into pleats which extend parallel to the cylindrical axis, and wherein said film layer is oriented outwardly.
